(19) United States
(12) Patent Application Publication
(10) Pub. No.: US 2015/0256260 A1
(43) Pub. Date: Sep. 10, 2015

(54) PLUGGABLE OPTICAL TRANSCEIVER WITH SHIELD FINGER RIGIDLY FIXED TO HOUSING

(71) Applicant: Sumitomo Electric Industries, Ltd., Osaka-shi (JP)

(72) Inventor: Hiromi KURASHIMA, Yokohama-shi (JP)

(21) Appl. No.: 14/638,379

(22) Filed: Mar. 4, 2015

(30) Foreign Application Priority Data
Mar. 5, 2014 (JP) 2014-042851

(51) Int. Cl. H04B 10/40

(52) U.S. Cl. CPC H04B 10/40

(57) ABSTRACT

An optical transceiver to be plugged into a cage of the host system is disclosed. The optical transceiver provides a shield finger that surrounds the optical transceiver and to be in contact with the cage. The shield finger provides a hook including a cut and a tab formed by the cut. The tab is hooked with the top housing of the optical transceiver so as not to interfere the insertion of the optical transceiver into the cage.

### BACKGROUND OF THE INVENTION

1. Field of the Invention

The present invention relates to an optical transceiver, in particular, the invention relates to a pluggable optical transceiver inserted into or extracted from a cage provided in a host system.

2. Related Background Art

One type of a pluggable optical transceiver has been known as the small form factor pluggable (SFP) transceiver whose outer dimensions and electrical interfaces with the host system are decided in one of multi-source agreements. The SFP transceiver has a longitudinal housing and a shield finger surrounding the housing and to be in contact with an inner surface of the cage when the pluggable optical transceiver is set within the cage. The shield finger is usually formed by cutting and bending a metal plate and includes a frame surrounding the housing and ground fingers extending from the frame. However, pluggable optical transceivers are presumed to be set within a cage prepared in the host system. The shield finger is required not to interfere with the insertion/extraction of the pluggable optical transceiver into/from the cage. Various structures have been proposed in prior arts to assemble the shield finger with the housing of the pluggable optical transceiver.

### SUMMARY OF THE INVENTION

An aspect of present application relates to the optical transceiver, which is plugged into a cage prepared in the host system. The optical transceiver includes an optical receptacle, housing, and a shield finger. The optical receptacle receives an external optical connector. The housing, which encloses an electronic circuit and an optical component, is continuous to the optical receptacle. The shield finger warps an interface between the optical receptacle and the housing. A feature of the present optical transceiver is that the shield finger provides a hook engaged with art inner surface of the housing passing through the hole.

### BRIEF DESCRIPTION OF THE DRAWINGS

The foregoing and other purposes, aspects and advantages will he better understood from the following detailed description of a preferred embodiment of the invention with reference to the drawings, in which:

FIG. 1 is an outer appearance of the optical transceiver 1 of the present embodiment;

FIG. 2 is an exploded drawing of the optical transceiver, where the optical transceiver 1 viewed from the top;

FIG. 3 is a plan view magnifying a front of the body 2;

FIG. 4 is a perspective view of the shield finger;

FIGS. 5A and 5B show a cross section of the tab and the hole to which the tab is engaged;

FIG. 6 is a plan view of the shield finger;

FIG. 7 shows an inside of a front portion of the top housing;

FIG. 8 is a plan view of the outer surface if the top housing opposite to that shown in FIG. 7;

FIG. 9 shows a cross section of the opening with a step;

FIGS. 10A to 10C show statuses of the optical transceiver inserted into the cage;

FIG. 11 is a perspective view of the front portion of another optical transceiver according to the second embodiment of the invention

FIG. 12 magnifies the shield finger of the second embodiment; and

FIG. 13 magnifies the shield finger according to the third embodiment of the present invention.

### DESCRIPTION OF THE EMBODIMENTS

Next, some embodiments according to the present invention will be described as referring to drawings. In the description of the drawings, numerals or symbols same with or similar to each other will refer to elements same with or similar to each other without duplicating explanations.

### First Embodiment

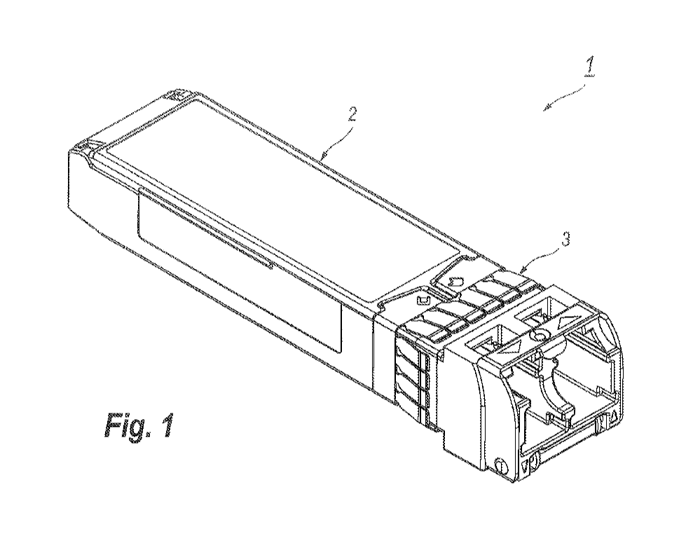

An optical transceiver of the present invention is applicable to the optical communication system. In particular, an optical transceiver is a basic component to convert signals between the electrical form and the optical form. The optical transceiver of the present embodiment is to be inserted into a cage prepared in the host system of the optical communication system. FIG. 1 is an outer appearance of the optical transceiver 1 of the present embodiment, where the optical transceiver 1 roughly comprises a primary portion 2 and a shield finger 3.

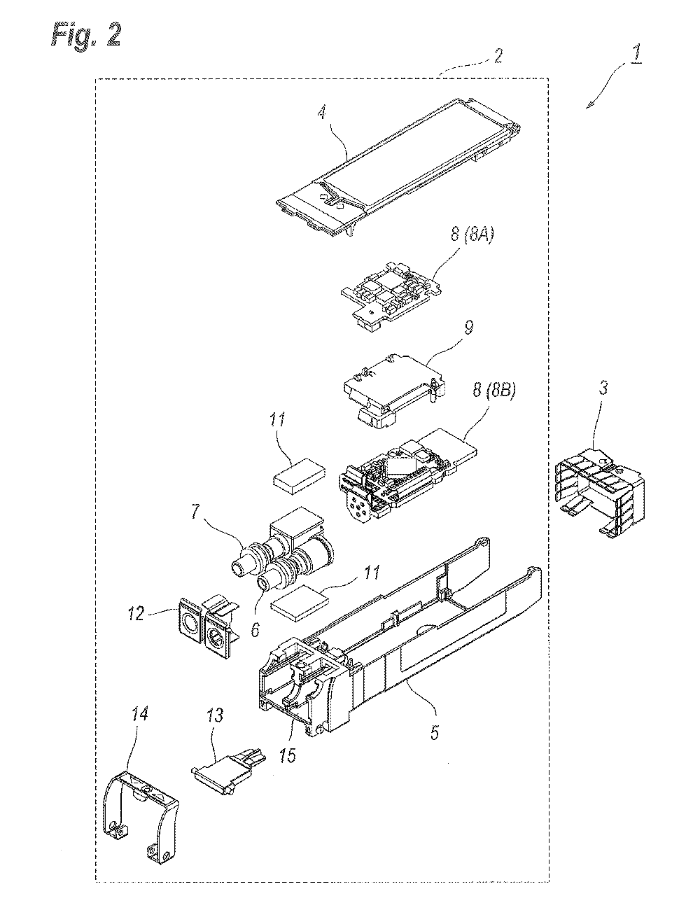

FIG. 2 is an exploded view of the optical transceiver 1, where the optical transceiver 1 is viewed from the top thereof. The primary portion 2 includes a top housing 4, a bottom housing 5, a receiver subassembly 6, a transmitter subassembly 7 circuit boards 8 and 8, a holder 9, heat spreaders 11, a shield partition 12, an no actuator 13, and a bail 14. The explanation below assumes “forward” or “front” in a side where the receiver subassembly 6 and the transmitter subassembly 7 are installed viewed from the circuit board 8, and “rear” or “back” in a side opposite to the front.

The top housing 4 and the bottom housing 5 extend longitudinally from the front to the rear and form an inner space within which the receiver subassembly 6, the transmitter subassembly 7, the circuit boards, 8 and 8, the holder 9, and the heat spreaders 11 are installed. The top housing 4 has a function of a ceiling to cover the inner space, and the bottom housing 5 provides a bottom and sides to form the inner space. Thus the inner space is electrically shielded by the top housing 4 and the bottom housing 5. The bottom housing 5 provides an optical receptacle 15 in the front end thereof to receive an external optical connector therein.

Two subassemblies, 6 and 7, are placed in side by side in the front of the inner space. The receiver subassembly 6 is electrically connected to the circuit board 8 with a flexible printed circuit (FPC), and the transmitter subassembly 7 is also connected to the circuit hoard 8 with another FPC. An electrical signal converted from a received optical signal by the receiver subassembly 6 is transmitted to the circuit board 8 via the FPC, and another electrical signal generated by the circuit board 8 is sent to the transmitter subassembly 7 through another FPC.

The circuit board 8 of the present embodiment includes a upper substrate 8A and a lower substrate 8B, where both substrates, 8A and 8B, mount electronic components thereon constituting electronic circuits such as a driver to generate a driving signal sent to the transmitter subassembly 7 via the FPC to drive the transmitter subassembly 7 and an amplifier to amplify the electrical signal provided from the receiver subassembly 6 via the FPC.

The holder 9 is put between the upper and lower substrates, 8A and 8B, and rigidly holds the substrates, 8A and 8B. Although the present embodiment provides the upper and lower substrates, 8A and 8B, the optical transceiver 1 may install only one substrate to mount the electronic circuits above described. In such an arrangement, the holder 9 becomes unnecessary. The heat spreaders 11 dissipates heat generated by the receiver subassembly 6, the transmitter subassembly 7, and the electronic circuits mounted on the substrates, 8A and 8B, to the top housing 4 and the bottom housing 5. The heat spreaders 11 are optionally prepared for electrical and optical components that generate heat.

The shield partition 12 prevents EMI radiations generated in the inner space of the primary portion 2 from leaking externally. The actuator 13 and the bail 14 are assembled in the front end of the bottom housing 5. The actuator 13 provides a projection latched with the cage when the optical transceiver 1 is set in the cage and the projection once latched with the cage prevents the optical transceiver 1 from slipping out from the cage. The bail 14, which works with the actuator 13, may release the engagement of the projection of the actuator 13 with the cage. Then, the optical transceiver 1 may be extracted from the cage.

The optical transceiver 1 may operate in a transmission speed exceeding 10 Gbps, which means that EMI radiations of high frequencies are generated within the optical transceiver. The EMI radiations are easily leaked out from the optical transceiver 1 as frequencies thereof becomes higher. The optical transceiver 1 of the present embodiment provides, as mechanisms to prevent the EMI radiations from leaking out, the inner space is tightly shielded by the top housing 4, the bottom housing 5, and the shield partition 12. In addition, the top housing 4 and the bottom housing 5 are grounded to the cage by an electrically conductive component accompanied with a physically elastic function.

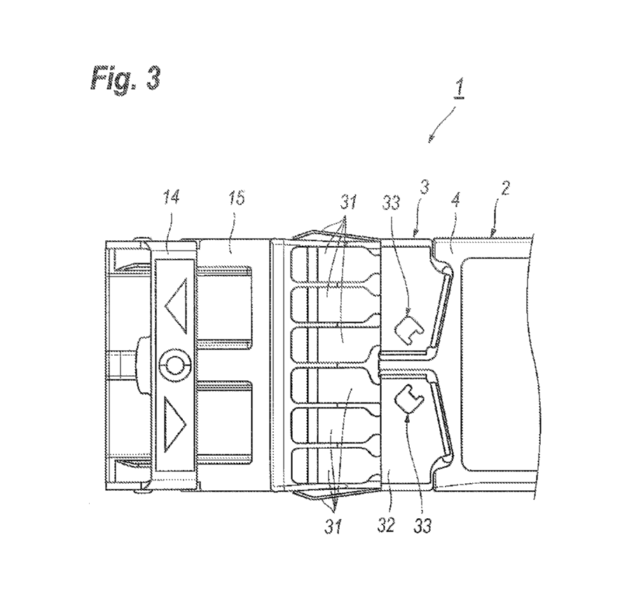

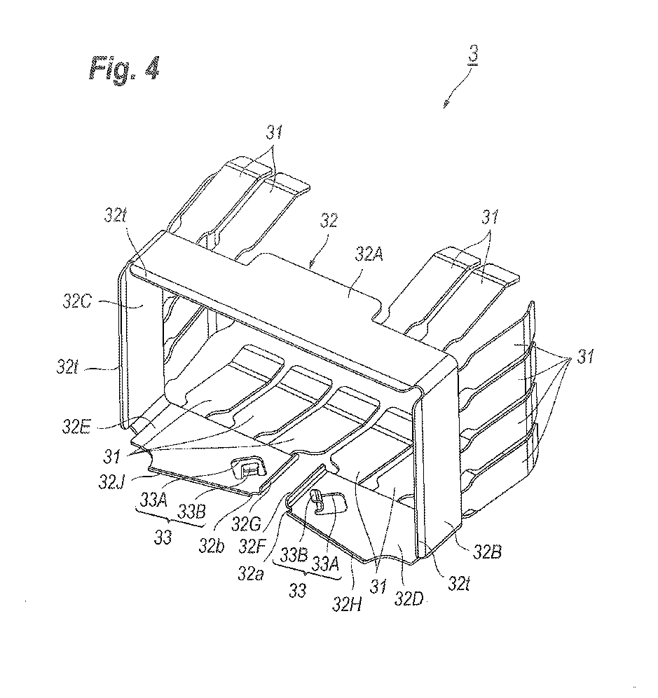

The shield finger 3 is the component providing the physically elastic function and made of electrically conductive material. FIG. 3 is a plan view showing a front portion of the primary portion 2; and FIG. 4 is a perspective view of the shield finger 3. As shown in FIG. 3, the shield finger 3 surrounds portions between the optical receptacle 15 and two housing, 4 and 5, and physically and electrically in contact with the cage. Referring to FIG. 4, the shield liner 3 includes a frame 32, a plurality of ground fingers 31 and two hooks 33. The frame 32 surrounds the top and bottom housings, 4 and 5, that is, the frame 32 has a rectangular shape with four portions, 32A to 32E, each facing respective surfaces of the top and bottom housings, 4 and 5. The ground fingers 31 extend toward the optical receptacle 15 from the front edge of the frame 32 and are elastically in contact with the cage.

The hooks 33, which have a U-shape, are hooked with rectangular holes 41 prepared in the top housing 4 and having a depth greater than 1 mm. The hooks 33 and the holes 41 are mechanism to assemble the shield finger 3 with the top housing 4. A feature of the hooks 33 and the rectangular holes 41 of the present embodiment is that they are arranged in diagonal, or not in parallel and not in perpendicular, to the longitudinal direction of the optical transceiver 1, where the longitudinal direction is the direction along which the optical transceiver 1 is set within the cage. This arrangement of the hooks 33 and the openings 41 may effectively secure the smooth insertion of the optical transceiver 1 into the cage without interfering with an undulation of the cage shell.

Referring to FIG. 4 the ground fingers 31 extend from the front edges of respective portions, 32A to 32E. Specifically, the ground fingers 31 extend from the edges of respective portions, 32A to 32E, frontward and outward, and bend inward at respective end portions so as to form a convex blade. Inserting the optical transceiver 1 into the cage, tops of the convex blades are in contact with the inner surface of the cage. Also, the ground fingers 31 are bent at respective roots at the front edges of the portions, 32A to 32E, which cause moderate repulsive forces against the cage and secure the physical contact between the top of the ground finger 31 and the cage.

The frame portions, 32A to 32C, except for the portions, 32D and 32E, are bent inwardly at respective rear edges 32t. These rear edges 32t are set within the grooves formed in the bottom housing 5. The rear edges 32t bent inward may avoid the interference of the sides, 32A to 32C, with the insertion port of the cage. The rest portions, 32D and 32E, facing the top housing 4 also provides respective rear edges, 32H and 32J, bent inward, and edges, 32F and 32G, facing to each other also bent inward. These edges, 32F to 32J, are set in respective grooves 43 prepared in the top housing 4. As shown in FIG. 4, the edges, 32F and 32G, in respective top frames, 32D and 32E, longitudinally extend as facing to each the other, which may be called as flaps. The other edges, 32H and 32J make a substantial angle with respect to the longitudinal axis of the optical transceiver 1, that is, the top frames, 32D and 32E, have a width close to respective center portions narrower than a width close to respective side portions, 32B and 32C.

This arrangement of the rear edges, 32H and 32J, namely, making the substantial angle against the longitudinal direction of the optical transceiver 1, the edges, 32H and 32J, become in contact with the edge of the cage at only one point. Moreover, this point smoothly slides on the edge of the cage along the insertion of the optical transceiver 1 into the cage.

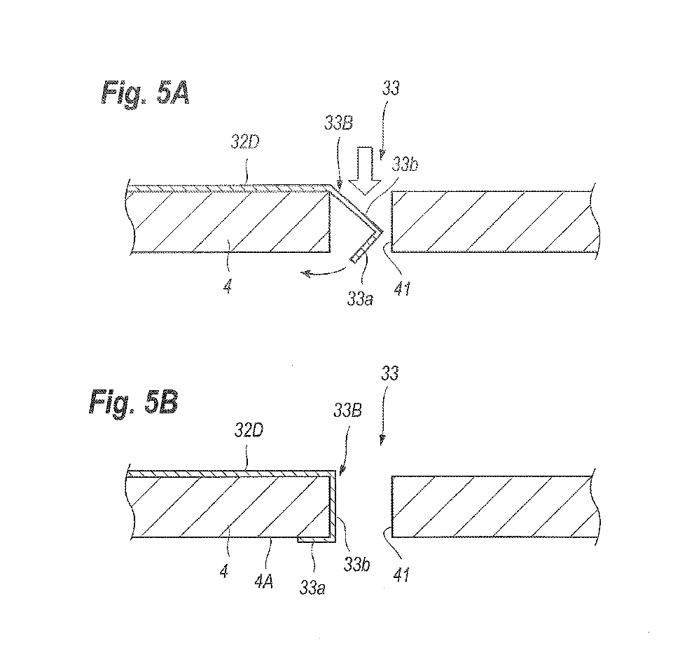

The hook 33 provides a cut 33A with a U-shape and a tab 33B surrounded and formed by the cut 33A, where the tab 33B is bent inwardly twice to form a U-shaped cross section. FIGS. 5A and 5B show a cross section of the tab 33B and the hole 41 of the top housing 4 to which the hook 33 is engaged. Specifically, the tab 33B provides two bends, a tip bend and a root bend, an end tab 33a between the tip and the tip bend, and an intermediate tab 33b between the tip bend and the root bend. The tab 33B has a shape to shown in FIG. 5A before the shield finger 3 is attached to the top housing 4, that is, the angle of the root bend is set in an obtuse angle, but the other bend, the tip bend, is set in substantially a right angle.

Assembling the shield 3 with the top housing 4 and setting the tab 33B into the hole 41, the intermediate tab 33b is further bent inwardly until the end bend becomes a right angle such that the end tab 33a is hooked on the inner surface 4A of the top housing 4, as shown in FIG. 5B. Thus, the shield finger 33 is tightly engaged with the top housing 4. In order to perform thus described engagement between the tab 33B and the hole 41 of the top housing 4, the intermediate tab 33b has a length substantially equal to a thickness of the top housing 4.

The tab 33B has a width of about 0.5 mm and a length of about 1.0 mm before it is bent twice, and the cut 33A to form the tab 33B has a width of about 1.0 mm. Thus, the arrangement of the hook 33 and the process to engage the hook 33 with the hole 41 may be visually inspected.

The cut 33A possibly lowers the stiffness of the shield finger 3. However, the shield finger 3, in particular the respective portions, 32A to 32E, surround the top and bottom housings, 4 and 5, each providing the rear edges, 32t, 32H, and 32J, and the flaps, 32F and 32G, in the sides, 32D and 32E; the shield finger 3 ensures the stiffness thereof.

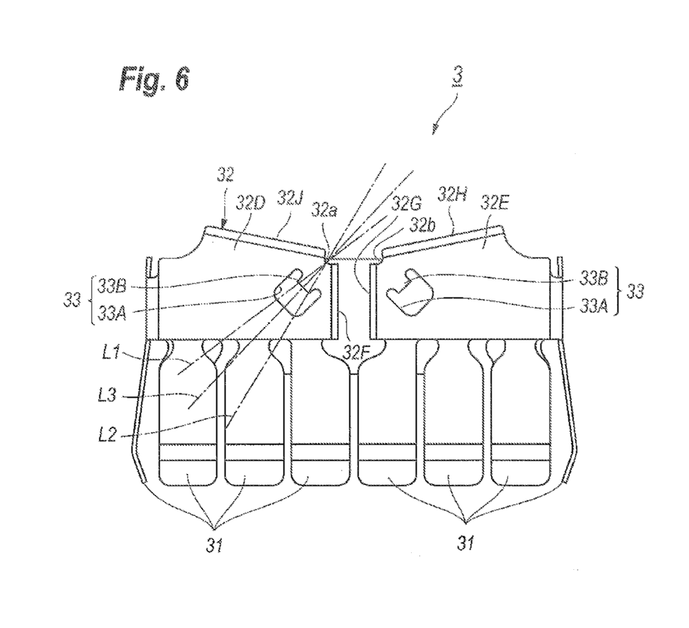

FIG. 6 is a plan view of the shield finger 3. Assuming status where the shield finger 3 provides no hook 33, the shield finger 3 has no reinforcement along lines, L1 and L2, connecting a corner 32a of two edges, 32J and 32F, and the ground finger 31. Under such a case, the top frame 32D is likely to be turned up with the line L3 as an axis.

The present embodiment enhances the stiffness of the top frame 32D by the existence of the hook 33. That is, the hook 33 is formed so as to cross the lines, L1 and L2, and the tab 33B just faces the corner 32a to intersect the line L3 by a right angle. The tab 33B, which is bent twice, faces the corner 32a, and the stiffness of the top frame 32D may be maintained. The other frame 32E has the arrangement of the tab 33B same with that in the frame 32D.

The lines, L1 and L2, along which the top frames are easily deformed, radially extend from the corner 32a, and the hook 33 is formed so as to cross the lines, L1 and L2. That is, the lines, L1 and L2, are drawn to bisect the angle between the rear edge 32J and the flap 32F. The arrangement of the hook 33 may be optional. For instance, a hook having a narrower width may be formed closer to the corner 32a. Thus, a feature of the hook 33 is to be formed so as to cross the lines radially extended from the corner 32a (or 32b) so as to bisect the angle of the corner 32a (or 32b).

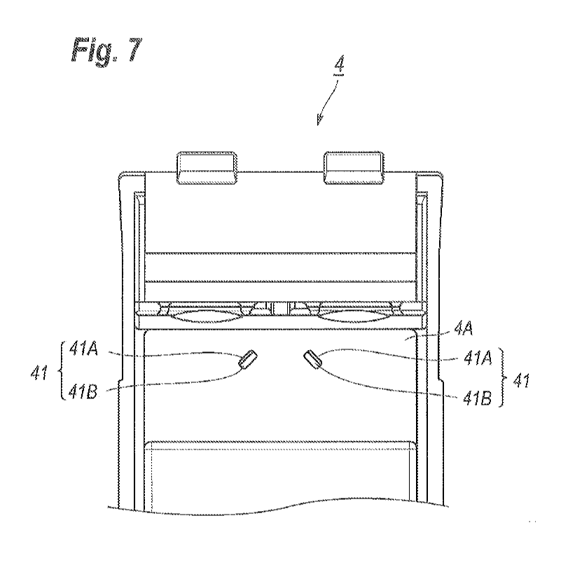

FIG. 7 shows an inside 4A or a front portion of the top housing 4. The top housing 4 provides two rectangular hole 41A whose dimensions are similar to those of the hook 33. The bole 41A has a depth which is 60 to 70% of a width thereof. The hole 41A may be formed by milling. The latching of the hook 33 with the hole 41A is carried by inserting the tab 33B into the hole 41A. When the hole has a depth greater than a width thereof, an aspect to ratio of the hook 33 increases and the latching of the hook 33 with the hole 41A could be probably weakened. The hole 41A of the present embodiment enhances the aspect ratio thereof, that is, the depth is smaller than the width.

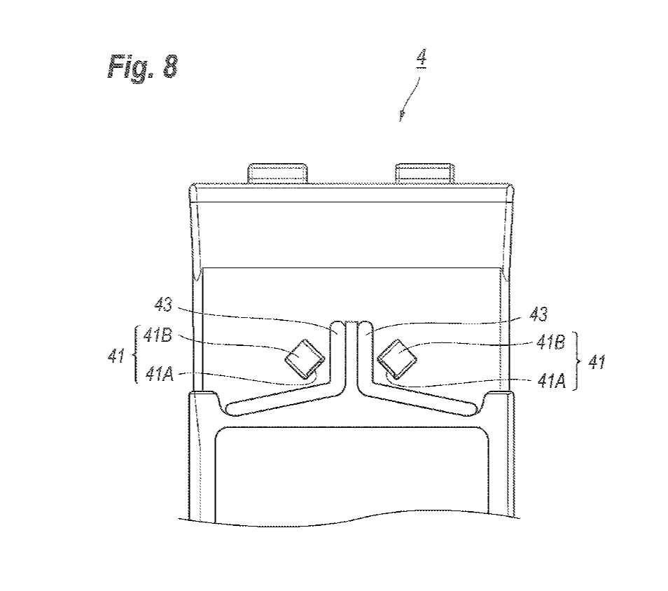

Specifically, the hole 41A of the present embodiment is formed by two steps. FIG. 8 is a plan view of the outer surface of the top housing 4, which is opposite to that shown in FIG. 7, The top housing 4 may be formed by die casting. Specifically, the die casting injects resin in a space formed between the upper die and the lower die, and a hole piercing the housing may be formed by preparing a pin or some other elements and setting the elements within the space between the dies so as to be in contact to both dies. Thus, portions the elements are set are not filled with resin and become openings.

In the present embodiment, an element attached to one of the die and another element attached to the other element are set offset but partly overlapped. Those arrangements of the elements may form a hole with a step therein. Moreover, in the present embodiment, the element attached to the upper die has a size greater than a size of the other element attached to the lower die, which secures the overlap relation between two elements.

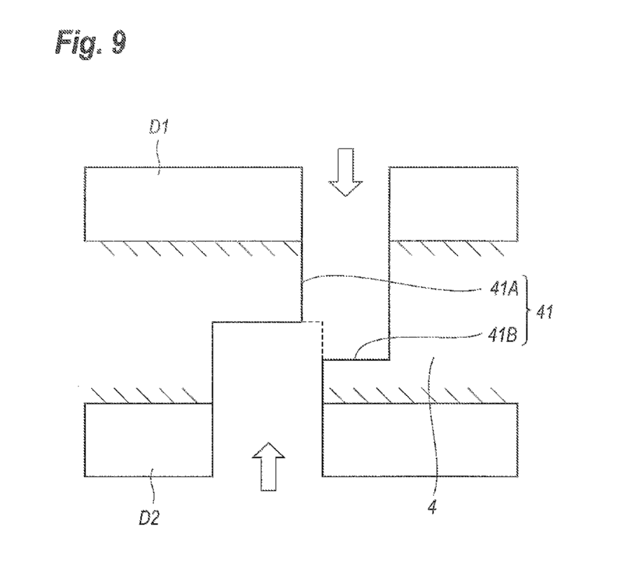

Specifically, as shown in FIGS. 7 and 8, the hole formed in the outer surface has a size larger than the hole formed in the inner surface 4A and partly overlaps therewith. Two openings overlap in an area of 0.1 mm length and 0.3 mm width, that is, a hole with a dimension of 0.1×0.3 mm² is formed. The hook 33 is hooked in the a step formed within the hole 41A. FIG. 9 shows a cross section of the hole 41A. with a step therein.

On the other hand, the hole 41A piercing the top housing 4 becomes a leak path for the EMI radiation from the inside of the housing 2. Accordingly, the hole 41A is preferably as small as possible. Specifically, the size of the hole 41A is preferably 1/10 to 1/20 at most of wavelengths of EMI radiations to be shielded. The optical transceiver 1 of the present embodiment operates at 10 Gbps, which means that high frequency signals with frequencies at least 5 GHz. should he considered. Accordingly, the hole 41A preferably has a size of 1.5 to 3.0 mm at most, and 0.75 to 1.5 mm at most for the signal of 20 GHz.

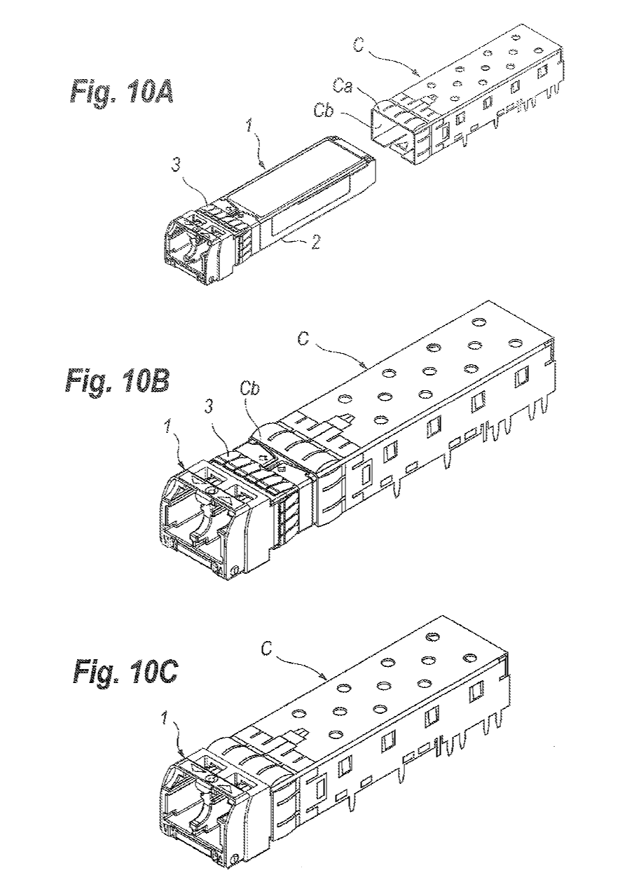

A set or an insertion of the optical transceiver 1 into the cage will be described. The optical transceiver 1 is inserted into the cage C from the rear thereof, as shown in FIG. 10A. Further inserting the optical transceiver 1 into the cage C, the rear edge of the shield finger 3 comes in contact with the edge Ca of the port Cb, but only one point on the rear edge 32H or 32J is in contact with the edge Ca. Still further inserting into the cage C, the ground fingers 31 of the shield finger 3 are fully set within the cage C so as to be in contact with the inner surface thereof.

### Second Embodiment

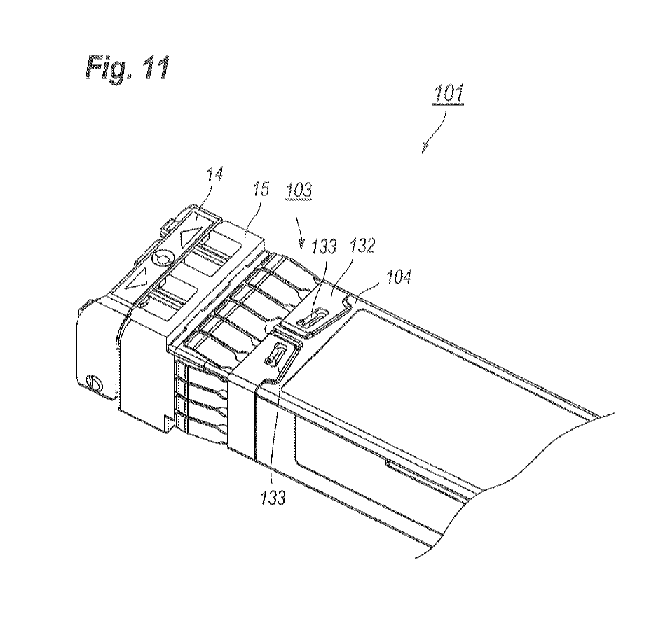

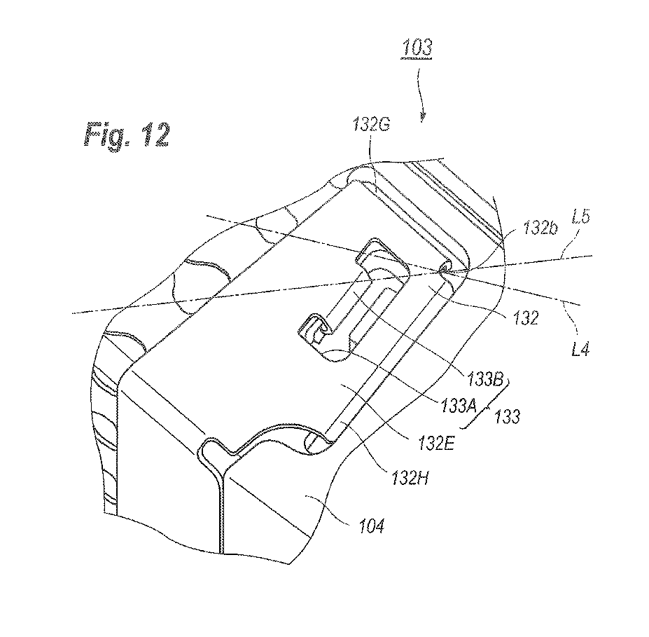

FIG. 11 is a perspective view of the front portion of another optical transceiver 101 according to the second embodiment of the invention, and FIG. 12 magnifies the shield finger 103 thereof. The shield finger 103 of the second. embodiment provides a hook to 133 including a cut 133A different from the hook 33 with the cut 33A of the former embodiment.

Similar to the aforementioned embodiment, the side 132E of the frame 132 is easily deformed along the lines, L4 and L5, extending from the corner 132b. Forming the hook 133 with an as enhanced width so as to cross the lines, L4 and L5, the frame 132 becomes hard to be deformed. In order to avoid the cut 133A or the tab 133B interfered with the edge of the cage C, the hook 133 is preferably to be formed so as to make an inclined angle with respect to the longitudinal direction of the optical transceiver 101 and to be formed in an extended width. However, a hook with an enhanced width, which equivalently expands an aspect ratio of the depth of the hook 133 against the width, leaves anxiety for reducing tolerance to the hooking.

The hook of the present embodiment has the C-shaped cut 133A and the tab 133B extending within the cut 133A, which forms the C-shape with partially widened cut width. This arrangement may make the avoidance of the interference with the edge of the cage to be consistent with the stiffness of the frame 132. The present embodiment has the C-shaped cut 133A; but the frame 132 may have an H-shaped cut. The shield finger 103 of the present embodiment, similar to the aforementioned embodiment, provides the hook 133 with the tab 133B hooked with the top housing 104 of the optical transceiver 101. Accordingly, the frame 132 is hard to be peeled of even when the optical transceiver 101 is set within the cage of the host system.

### Third Embodiment

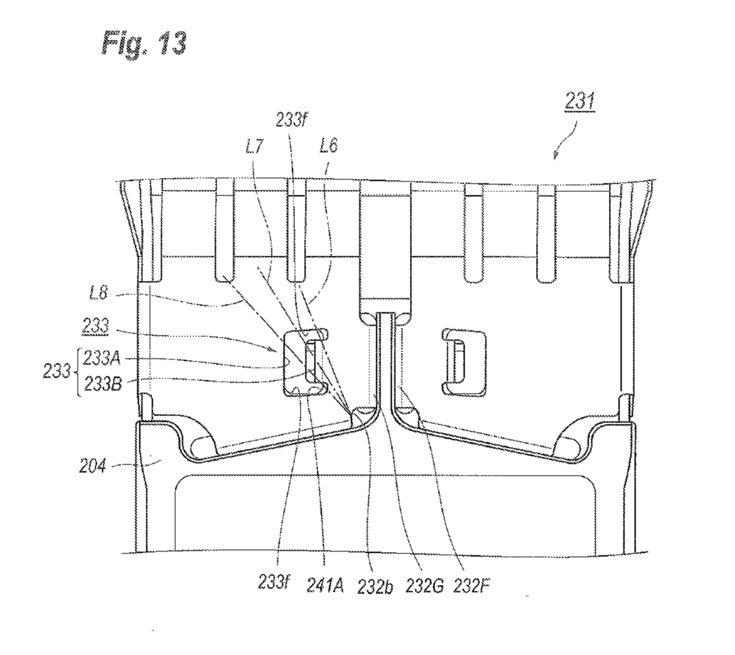

FIG. 13 magnifies the shield finger according to the third embodiment of the present invention, where the hook 233 is arranged longitudinally. That is, the hook with the width is formed such that the width thereof is in parallel to the longitudinal direction of the optical transceiver, namely, in parallel to the flaps, 232F and 232G, of the frame 232. The hook 233 of the present embodiment also crosses the lines, L6 and L7, brought out from the corner 232b diagonally. This arrangement of the hook 233 may expand the width of the hook 233, and the stiffness of the frame 232 along the longitudinal direction of the optical transceiver 1 may be further enhanced.

Moreover, the cut 233A has edges 233f facing to each other and extending so as to intersect the longitudinal direction of the optical transceiver 1 by an angle deviated from the right angle; the optical transceiver 1 with the shield finger 231 may be smoothly inserted into and extracted from the cage of the host system without interfering. The embodiment of the hook 233 shown in FIG. 13 has the tab 233B whose distal end is inserted into the hole 241A of the top housing 204 and hooked thereby.

In the foregoing detailed description, the apparatus of the present invention have been described with reference to specific exemplary embodiments thereof. It will, however, be evident that various modifications and changes may be made thereto without departing from the broader spirit and scope of the present invention. The present specification and figures are accordingly to be regarded as illustrative rather than restrictive.

What is claimed is:

1. An optical transceiver to be plugged into a cage prepared in a host system, comprising:
an optical receptacle configured to receive an external optical connector;
a housing configured to enclose an electronic circuit and an optical component, the housing being continuous to the optical receptacle and having a hole; and
a shield finger that warps an interface between the optical receptacle and the housing, the shield finger providing a hook engaged with an inner surface of the housing passing through the hole.

2. The optical transceiver of claim 1,
wherein the shield finger includes a frame surrounding the housing and a plurality of ground fingers extending from the frame toward the optical receptacle,
wherein the frame provides the hook with a cut and a tab formed by the cut, the tab being bent twice to form an end tab to he engaged with the housing.

3. The optical transceiver of claim 1,
wherein the shield finger includes a frame and a ground fingers, the frame wrapping the housing as leaving a gap between respective ends of the frame, the gap extending along a longitudinal direction of the optical transceiver, the respective ends and edges of the frame continuous to the respective ends making a corner with an obtuse angle, and
wherein the hook faces the corner.

4. The optical transceiver of claim 3,
wherein the hook crosses a line extracted from the corner diagonally toward another corner opposite to the corner so as to bisect the obtuse angle.

5. The optical transceiver of claim 3,
wherein the hook includes a tab with a width making a right angle with respect to the line diagonally extracted from the corner.

6. The optical transceiver of claim 3,
wherein the hook includes a tab with a width extending in parallel to the edges each continuous to the respective ends, and
wherein the width intersects the line diagonally extracted from the corner.

7. The optical transceiver of claim 3,
wherein the hook includes a tab with a width extending in parallel to the respective edges of the frame.

8. The optical transceiver of claim 3,
wherein the rear edges are bent within respective grooves formed in the housing.

9. The optical transceiver of claim 1,
wherein the tab includes an end tab and an intermediate tab, the end tab being engaged with the inner surface of the housing passing through the hole, the intermediate tab having a length substantially equal to a thickness of the housing.

10. The optical transceiver of claim 9,
wherein the tab includes an end tab and an intermediate tab, and the hole includes a step to be engaged with the end tab, the intermediate tab having a length substantially equal to a length from an outer surface of the housing to the step.
